(19) United States
(12) Patent Application Publication
(10) Pub. No.: US 2005/0193146 A1
(43) Pub. Date: Sep. 1, 2005

(54) Hierarchical dispatching

(76) Inventor: Stephen M. Goddard, Lincoln, NE (US)

Correspondence Address: HARNESS, DICKEY, & PIERCE, P.L.C, 7700 BONHOMME, STE 400, ST. LOUIS, MO, 63105, US

(21) Appl. No.: 10/989,243

(22) Filed: Nov. 15, 2004

Related U.S. Application Data
(60) Provisional application No. 60/523,858, filed on Nov. 20, 2003.

(51) Int. Cl. G06F 15/173

(52) U.S. Cl. 709/238

(57) ABSTRACT

A cluster-based server system includes at least a first dispatcher, a second dispatcher, and one or more servers. The first dispatcher is configured for sending packets received by the first dispatcher to the second dispatcher, and the second dispatcher is configured for forwarding packets received from the first dispatcher to the one or more servers for processing. A computerized method for processing packets in a cluster-based server includes receiving a packet with a first stage dispatcher, sending the received packet from the first stage dispatcher to one of a plurality of second stage dispatchers, and forwarding the received packet from said one of the second stage dispatchers to one of a plurality of servers for processing.

### CROSS-REFERENCE TO RELATED APPLICATIONS

This application claims priority to U.S. Provisional Application No. 60/523,858 filed on Nov. 20, 2003, the entire disclosure of which is incorporated herein by reference.

### BACKGROUND OF THE INVENTION

A variety of servers are known in the art for serving the needs of millions of computer network users. More recently, cluster-based servers have been developed, where a pool of “back-end” servers are tied together to act as a single unit, typically in conjunction with a dispatcher that shares or balances the load across the server pool. While useful for a variety of server applications, cluster-based servers are often configured as Web servers for providing requested resources to users over the Internet.

Server clustering technologies are broadly classified as: OSI layer four switching with layer two packet forwarding (L4/2); OSI layer four switching with layer three packet forwarding (L4/3); and OSI layer seven (L7) switching with either layer two packet forwarding (L7/2) or layer three packet forwarding (L7/3) clustering. These terms refer to the techniques by which the servers in the cluster are tied together. An overview of these clustering technologies is presented in Schroeder, T., S. Goddard and B. Ramamurthy, Scalable Web Server Clustering Technologies, IEEE Network, Vol. 14, No. 3 pp. 38-45, 2000.

By definition, the dispatcher in a cluster-based server manages multiple back-end servers. There are, however, practical limits on just how many back-end servers any given dispatcher can manage.

Firewalls are also known in the art, and are commonly used by organizations and, increasingly, individuals to protect computer networks from external threats including “hackers” coming from other networks, such as the Internet. A typical firewall inspects packets flowing across a network boundary and allows or denies access to internal/external servers according to defined policies. It thus forms a line of defense in securing internal or private networks from, e.g., the Internet. However, in a single firewall system, the firewall represents a single point of failure; if the firewall is down, all access is lost. The single firewall may also create a throughput bottleneck.

Firewall sandwiches can be used to remove the single point of failure as well as the potential bottleneck of a single firewall. A typical firewall sandwich is illustrated in FIG. 1, and includes two or more (e.g., three) firewalls configured in parallel with firewall load balancers (FLBs) on opposite sides of the firewalls. The FLBs are logically positioned at network boundaries and ensure that TCP/IP traffic specific to a particular connection passes through the same firewall in both directions. Since connection requests may originate and terminate in either internal or external networks (illustratively labeled private network and public network, respectively, in FIG. 1), the two FLBs perform symmetric operations, especially if the firewalls do not perform network address translation (NAT).

The general operation of the firewall sandwich shown in FIG. 1 will now be described. For simplicity, assume that Ethernet is used for the physical network, the firewalls (FWs) do not perform network address translation, and all traffic is TCP/IP. Under these assumptions, the processing performed by the FLBs is symmetric with respect to the flow of traffic from the public network to the private network, and vice versa.

When the FLB positioned at the public network boundary receives a SYN packet from the public network (indicating a new TCP/IP session), the FLB selects a FW through which the session traffic will flow. Common algorithms for selecting a FW include predefined (static) selection based on IP and port numbers, Round Robin, Weighted Round Robin, Least Connections, and Least-Packet Throughput. The FLB forwards the packet to the selected FW by changing the Ethernet destination MAC address of the packet to the address of the selected FW. The FLB then changes the source MAC address to its own address and places the packet onto the subnet connecting the FLB to the set of FWs.

The selected FW receives the SYN packet and decides whether the packet (and the session) is allowed to pass based on defined security policies. Assuming the packet is allowed to pass through the FW, it is forwarded to the FLB on the other side of the sandwich. This is achieved by identifying such FLB as a network gateway for the subnet it shares with the FWs.

For connection-oriented protocols, such as TCP/IP, all packets for a given session are forwarded to the same FW (in both directions), unless the FWs share state information. Assuming the FWs do not share state information (as is the case for most commercially available FWs), when the SYN packet passes through the second FLB, the FLB recognizes it as having come from a FW, records the FW through which the packet passed and forwards the packet to its destination or to its next hop in the network. (Note that when static FW selection algorithms are used, the processing performed by the second FLB is reduced and may be bypassed completely in some cases.)

When the FLB positioned at the public network boundary receives a packet other than a SYN packet, it determines whether it is part of an existing TCP session. This is often done using the source and destination IP addresses and the respective port numbers. Assuming the packet belongs to an existing TCP session, the FLB forwards it to the correct FW. The FW then forwards the packet to the second FLB, and so on. If the packet does not belong to an existing TCP session, the first FLB either discards the packet, or discards the packet and replies with an RST packet, or forwards the packet to one of the FWs for deciding the packet's fate.

As is known, the private computer network shown in FIG. 1 may include one or more computer servers, including a cluster-based server of the type described above. In such a case, the overall network would include the firewalls, the FLBs, a dispatcher, and multiple back-end servers.

### SUMMARY OF THE INVENTION

A cluster-based server system constructed according to one embodiment of the present invention includes at least a first dispatcher, a second dispatcher, and one or more servers. The first dispatcher is configured for sending packets received by the first dispatcher to the second dispatcher, and the second dispatcher is configured for forwarding packets received from the first dispatcher to the one or more servers for processing.

A cluster-based server system constructed according to another embodiment of this invention includes at least one first stage dispatcher, a plurality of second stage dispatchers, and a plurality of servers. The first stage dispatcher is configured for sending a packet received by the first stage dispatcher to one of the second stage dispatchers, and each second stage dispatcher is configured for forwarding packets received from the first stage dispatcher to one of the servers for processing.

A computerized method for processing packets in a cluster-based server according to another embodiment of this invention includes receiving a packet with a first stage dispatcher, sending the received packet from the first stage dispatcher to one of a plurality of second stage dispatchers, and forwarding the received packet from said one of the second stage dispatchers to one of a plurality of servers for processing.

According to other aspects of the present invention, various computer devices and system components can (but need not) be implemented in application-space on commercially-off-the-shelf (COTS) computer devices executing COTS operating system software.

Further areas of applicability of the present invention will become apparent from the detailed description provided hereinafter. It should be understood that the detailed description and specific examples, while indicating certain exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a prior art firewall sandwich interposed between public and private networks;

FIG. 2 is a block diagram of a multi-stage cluster-based server system according to the present invention;

FIG. 3 is a block diagram of a multi-stage cluster-based server system employing L4 and L7 dispatchers;

FIG. 4 is a block diagram of a multi-stage cluster-based server system having back-end servers each connected to multiple dispatchers;

FIG. 5 is a block diagram of one preferred multi-stage cluster-based server for supporting cookies;

FIG. 6 is a block diagram of a cluster-based server system having a firewall dispatcher configured for clustering back-end servers;

FIG. 7 is a block diagram of a multi-stage cluster-based server system having a firewall dispatcher configured for clustering subsequent stage dispatchers and back-end servers; and

FIG. 8 is a block diagram of a multi-stage cluster-based server system having second stage dispatchers that are firewall aware.

Like reference numerals indicate like elements or features throughout the several drawings.

### DETAILED DESCRIPTION OF EXEMPLARY EMBODIMENTS

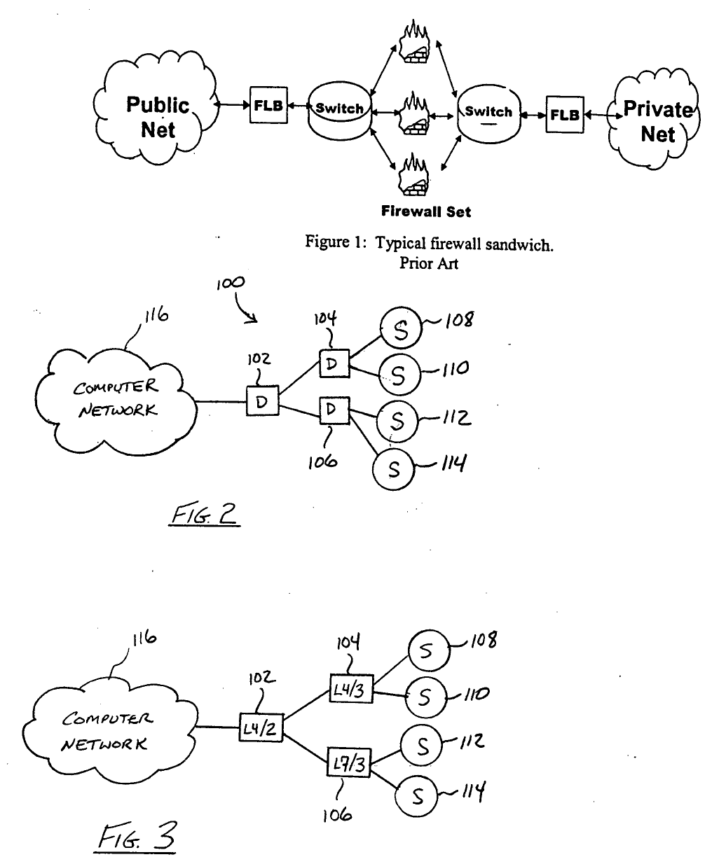

A cluster-based server system according to a first embodiment of the present invention is indicated generally as 100 in FIG. 2. As shown in FIG. 2, the system 100 includes multiple dispatchers 102, 104, 106 and multiple computer servers 108, 110, 112, 114 (also referred to as “back-end servers”). In this embodiment, dispatcher 102 is configured for sending packets received by the dispatcher 102 (e.g., packets received from the computer network 116 shown in FIG. 1) to one of the dispatchers 104, 106. Further, dispatchers 104, 106 are configured for forwarding packets received from the dispatcher 102 to one or more of the servers 108-114 for processing. In this manner, a highly scalable and configurable system 100 is advantageously provided, as further explained below.

In the embodiment of FIG. 2, dispatcher 104 manages a first set of servers 108, 110, and dispatcher 106 manages a second set of servers 112, 114, with dispatcher 102 forwarding packets received from the computer network 116 to the dispatchers 104, 106 according to a predetermined load distribution scheme (which may include load balancing). The dispatcher 102 is a first stage dispatcher, and dispatchers 104, 106 are second stage dispatchers, with the overall system 100 constituting a multi-stage, hierarchical cluster-based server system. Although the system 100 of FIG. 2 employs only two dispatching stages, it should be understood that a greater number of stages can be employed in any given application of this invention. Additionally, while two second stage dispatchers are employed in the embodiment of FIG. 2, it should be understood that a greater or lesser number of dispatchers can be utilized in the second stage and any subsequent stages.

When scaled up, the system 100 can support a “farm” of second stage dispatchers under management of the first stage dispatcher 102, with each second stage dispatcher managing a farm of back-end servers and/or third stage dispatchers.

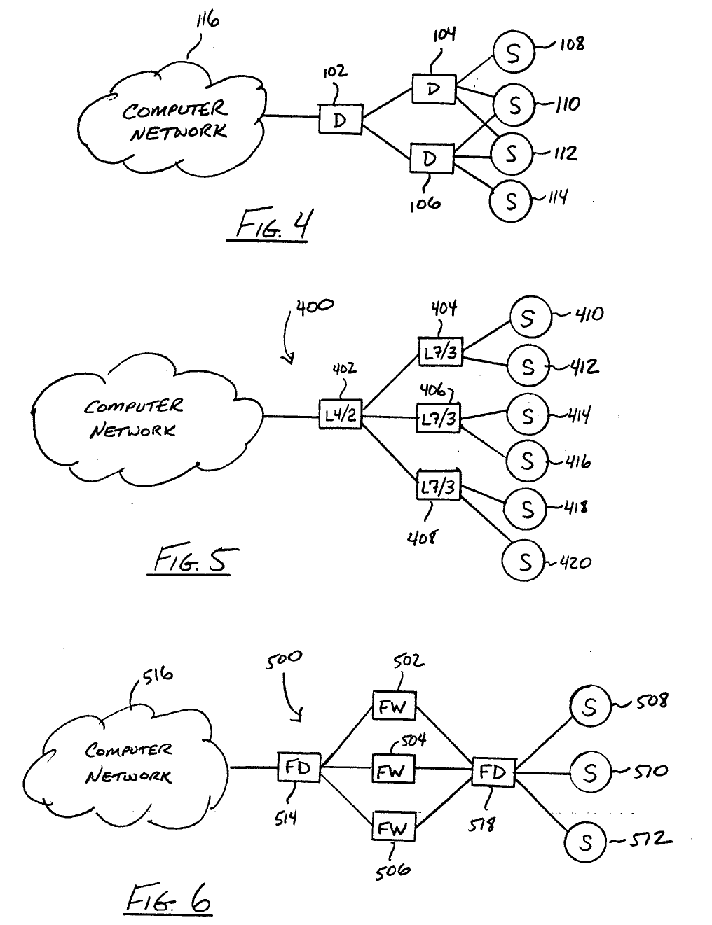

Each dispatcher 102-106 is preferably configured to implement OSI layer four switching (L4), OSI layer seven switching (L7), or any other suitable dispatching technology. In one exemplary embodiment, illustrated generally in FIG. 3, the first stage dispatcher 102 employs layer four switching with layer two packet forwarding (L4/2), one of the second stage dispatchers 104 employs layer four switching with layer three packet forwarding (L4/3), and the other second stage dispatcher 106 employs layer seven switching with layer three packet forwarding (L7/3). Among other benefits, this arrangement allows return traffic from the servers 108-114 to bypass the first stage dispatcher 102.

Each back-end server can be configured flexibly. For example, some servers can (but need not) be dedicated HTTP Web servers, dedicated FTP servers, dedicated SSL-supported Web servers, etc. Thus, packets of one type, such as HTTP packets, can be sent to one server, while packets of another type, such as those requesting FTP files, can be sent to another server, if desired. It is not necessary, however, for all same-service-providing servers (e.g., all dedicated HTTP Web servers) to be managed by the same dispatcher, as they can instead be managed by different dispatchers. Multi-service-providing servers may also be employed.

Additionally, it is not necessary for each server to be connected to only one dispatcher. Instead, each back-end server can be connected to multiple dispatchers at the same time, as illustrated generally in FIG. 4. As shown therein, dispatcher 104 is connected to servers 108-112, and dispatcher 106 is connected to servers 110-114. Thus, servers 110, 112 are connected to both second stage dispatchers 104, 106 in this exemplary embodiment. Alternatively, dispatchers 104, 106 can be connected to a greater or lesser number of the back-end servers 108-114. When one or more back-end servers are connected to multiple dispatchers, server configuration information can be established and shared with dispatcher modules via administration modules. Server configuration information can also be static or dynamic. For example, all HTTP traffic could be routed to server 110 and all FTP traffic to server 112, or each server may receive a fraction of the connection requests to a dispatcher and that fraction may vary over time based on a load allocation algorithm.

While no direct connections are shown between the first stage dispatcher 102 and one or more of the back-end servers 108-114 in FIGS. 2-4, it should be understood that the dispatcher 102 can be so configured. That is, in addition to forwarding packets received from the computer network 116 to the second stage dispatchers 104, 106, the dispatcher 102 may be configured to forward some packets received from the network 116 to one or more of the back-end servers 108-114 directly and thus bypass the second stage dispatchers 104, 106, if desired. In other words, the dispatcher 102 can be configured to function both as a conventional dispatcher for a cluster-based server system, and as a first stage dispatcher in a hierarchical multi-stage dispatching arrangement. Similarly, one or more of the second stage dispatchers may be directly connected to one or more back-end servers as well as one or more third stage dispatchers, etc.

The connections between the dispatchers and the back-end servers are preferably (but need not be) persistent TCP connections. Additional information regarding persistent TCP connections is disclosed in International Publication No. WO 02/037799, the entire disclosure of which is incorporated herein by reference.

One preferred embodiment for supporting cookies will now be described with reference to FIG. 5. The multi-stage hierarchical cluster-based server system 400 of FIG. 5 includes a first stage L4/2 dispatcher 402, multiple second stage L7/3 dispatchers 404-408, and multiple back-end servers 410-420. In this embodiment, each cookie contains information identifying the back-end server that created it. When a client initiates a TCP request, the L4/2 dispatcher 402 forwards the SYN packet to one of the L7/3 dispatchers, such as dispatcher 408. Therefore, a TCP connection is established between the client and the L7/3 dispatcher 408 (note that return traffic bypasses the L4/2 dispatcher 402). When the client subsequently sends an HTTP request packet with a cookie header, dispatcher 408 will examine the packet to determine which server created the cookie. For this example, assume that server 414 created the cookie. If every L7/3 dispatcher is connected to each back-end server, the dispatcher 408 will simply forward the cookie packet to the server 414 via a persistent TCP connection therebetween.

Alternatively, if there is no connection between the L7/3 dispatcher 408 and the server 414 (as is the case for the system 400 illustrated in FIG. 5), the dispatcher 408 must determine which of the other L7 dispatchers are connected to the server 414. For this purpose, the system 400 can maintain a central configuration file containing information about all connections between the L7 dispatchers and the back-end servers. By sharing this file with all L7 dispatchers, dispatcher 408 can query the file to identify an L7 dispatcher that is connected to the server 414 (which, in this example, is dispatcher 406). Alternatively, the system 400 can implement a broadcast mechanism among the L7 dispatchers, thus allowing dispatcher 408 to broadcast a message “who is connected to this server?” to the other L7 dispatchers. The L7 dispatcher 406 will then respond accordingly.

Upon determining that dispatcher 406 is connected to the server 414 that created the cookie (using the above methods or otherwise), dispatcher 408 can send the packet to the dispatcher 406 using layer two packet forwarding. After receiving this packet, dispatcher 406 can add an entry into a matching table (preferably dedicated for this purpose) that matches a persistent TCP connection between it and the server 414 to the source MAC address of the packet (i.e., the MAC address of the sending L7 dispatcher 408), and send the cookie packet to the server 414 for processing. Upon receiving a reply from the server 414, dispatcher 406 can query the matching table and send the reply back to the dispatcher 408 using layer two packet forwarding. Dispatcher 408 then sends the reply back to the client (again, bypassing the L4/2 dispatcher 402). Alternatively, other approaches can be employed for supporting cookies in a multi-stage hierarchical cluster-based server system according to the present invention.

All of the dispatchers shown in FIGS. 2-5 can be and preferably are implemented in application-space. As is known, software on a computer is generally characterized as either operating system (OS) software or applications. The OS software typically includes a kernel and one or more libraries. The kernel is a set of routines for performing basic, low-level functions of the OS such as interfacing with hardware. Applications are typically high-level programs that interact with the OS software to perform functions. The applications are said to execute in application-space. The functionality of the dispatchers of this invention can be implemented in the kernel, in applications, or in hardware. Moreover, the dispatchers can be implemented in application-space using commercially-off-the-shelf (COTS) hardware and COTS OS software. This is in contrast to custom hardware and/or OS software, which is typically more expensive and less flexible. Additional information regarding application-space implementations is disclosed in International Publication No. WO 02/43343, the entire disclosure of which is incorporated herein by reference.

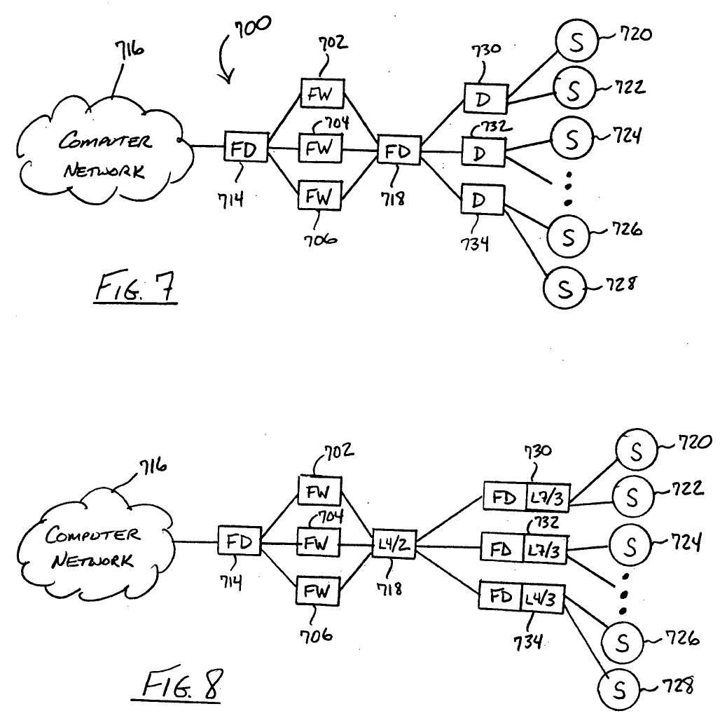

FIG. 6 illustrates a cluster-based server system 500 according to another embodiment of this invention. As shown in FIG. 5, the system 500 includes a plurality of firewalls 502-506, a plurality of back-end servers 508-512, a logically external firewall dispatcher 514 for dispatching packets from an external computer network 516 to the firewalls 502-506 (and vice versa), and a logically internal firewall dispatcher 518 for interfacing the firewalls 502-506 to the cluster of back-end servers 508-512. Similar to the FLBs shown in FIG. 1, the firewall dispatchers 514, 518 send packets to and receive packets from the firewalls 502-506 via switches (not shown).

In operation, the external firewall dispatcher 514 functions much like the logically external FLB shown in FIG. 1, and the internal firewall dispatcher 518 functions much like the logically internal FLB shown in FIG. 2. Additionally, in the system of FIG. 6, the internal firewall dispatcher 518 is configured to function as a dispatcher for managing the cluster of back-end servers 508-512. Thus, rather than receiving packets from an FLB, the internal firewall dispatcher 518 receives packets directly from the firewalls 502-506 (via a switch), and dispatches these packets to the back-end servers 508-512 according to a predetermined load distribution scheme (which may include load balancing). In other words, the internal firewall dispatcher 518 operates as a firewall load balancer in a firewall sandwich comprising the external firewall dispatcher 514 and the multiple firewalls 502-506, and also as a dispatcher in a cluster-based server comprising the back-end servers 508-512. While three firewalls 502-506 and three back-end servers 508-512 are shown in FIG. 6, it should be understood that a greater or lesser number of firewalls and/or servers may be employed in any given implementation.

In one preferred embodiment, the internal firewall dispatcher 518 and the external firewall dispatcher 514 both execute in application-space on COTS hardware running COTS operating system software. Thus, no special hardware or software modifications are required. Additionally, both firewall dispatchers 514, 518 can execute on the same machine, if desired. Further, the logically external firewall dispatcher 514 is preferably configured to monitor the internal firewall dispatcher 518 and take over for the internal firewall dispatcher upon detecting a failure. Conversely, the internal firewall dispatcher 518 is preferably configured to monitor and take over for the external firewall dispatcher 514 upon detecting a failure therein. In this manner, the firewall dispatchers 514, 518 provide redundancy for one another, thereby increasing system reliability.

The firewall dispatchers 514, 518 can be configured to implement any suitable dispatching technology, including L4/2, L4/3 and L7 clustering. They can also function solely as a firewall load balancer, or solely as a network-clustering dispatcher. Therefore, the firewall dispatchers of the present invention provide great flexibility in system design and operation.

FIG. 7 illustrates a cluster-based server system 700 according to another embodiment of the present invention. As shown in FIG. 7, the system 700 includes multiple firewalls 702-706, a logically external firewall dispatcher 714 for dispatching packets from an external computer network 716 to the firewalls 702-706 (and vice versa), and a logically internal firewall dispatcher 718 for interfacing the firewalls 702-706 to a cluster of back-end servers 720-728 via multiple second stage dispatchers 730-734. Thus, the system 700 is similar to the system 500 of FIG. 6 except that the firewall dispatcher 718 also serves as the first stage dispatcher of a multi-stage, hierarchical cluster-based server of the type described above with reference to FIGS. 2-5.

As with the embodiments of FIGS. 2-5, in the embodiment of FIG. 7, a greater or lesser number of dispatchers may be employed, as can a greater number of dispatching stages. Further, each dispatcher can be connected to one or more dispatchers in a subsequent stage as well as to one or more back-end servers directly, and each back-end server can be connected to multiple dispatchers at the same time, if desired. The system of FIG. 7 can also employ a greater or lesser number of firewalls, as apparent to those skilled in the art.

In one exemplary embodiment, illustrated in FIG. 8, the logically internal firewall dispatcher/first stage dispatcher 714 is configured to implement L4/2 dispatching, second stage dispatchers 730, 732 are configured as L7/3 dispatchers, and second stage dispatcher 734 is configured as an L4/3 dispatcher. Additionally, each second stage dispatcher is provided with a firewall dispatching module DF, as shown in FIG. 8. After receiving a SYN message from a firewall, the L4/2 dispatcher 714 embeds the firewall information into the SYN message and forwards the message to a selected or specified (e.g., IP specified) one of the second stage dispatchers 730-734 to be processed. The DF of such second stage dispatcher extracts the firewall information from the SYN message before passing it to the L7/3 (or L4/3, as applicable) module for processing. In this manner, the second stage dispatchers 730-734 are firewall aware, and can send responses directly to the firewalls (bypassing the first stage dispatcher 714). Thus, the traffic path is such that there are no single bottlenecks for the server response traffic.

In the embodiments of FIGS. 7 and 8, the internal and external firewall (and first stage) dispatchers 714, 718 may execute in application-space on COTS hardware running COTS operating system software. Thus, no special hardware or software modifications are required. Additionally, both firewall dispatchers 714, 718 can execute on the same machine, if desired, and both are preferably configured to monitor and take over for the other upon detecting a failure.

As apparent to those skilled in the art, the computer networks shown illustratively in FIGS. 2-8 may be, e.g., a local area network (LAN), a wide area network (WAN), the Internet, a combination of such networks, etc.

The description of the invention is merely exemplary in nature and, thus, variations that do not depart from the gist of the invention are intended to be within the scope of the invention. Such variations are not to be regarded as a departure from the spirit and scope of the invention.

1. A cluster-based server system, the system comprising at least a first dispatcher, a second dispatcher, and one or more servers, the first dispatcher configured for sending packets received by the first dispatcher to the second dispatcher, and the second dispatcher configured for forwarding packets received from the first dispatcher to said one or more servers for processing.

2. The system of claim 1 wherein the first dispatcher is an L4 dispatcher.

3. The system of claim 2 wherein the first dispatcher is an L4/2 dispatcher.

4. The system of claim 1 wherein the second dispatcher is an L4 or L7 dispatcher.

5. The system of claim 4 wherein the second dispatcher is an L4/3 or L7/3 dispatcher.

6. The system of claim 5 wherein the second dispatcher is an L7/3 dispatcher.

7. A cluster-based server system, the system comprising at least one first stage dispatcher, a plurality of second stage dispatchers, and a plurality of servers, wherein the first stage dispatcher is configured for sending a packet received by the first stage dispatcher to one of the second stage dispatchers, and each second stage dispatcher is configured for forwarding packets received from the first stage dispatcher to one of the servers for processing.

8. The system of claim 7 wherein the first dispatcher is an L4 dispatcher.

9. The system of claim 8 wherein the second dispatcher is an L4 or L7 dispatcher.

10. The system of claim 7 wherein each server is connected to at least one second stage dispatcher.

11. The system of claim 10 wherein at least one server is connected to a plurality of second stage dispatchers.

12. The system of claim 10 wherein at least one server is connected to a plurality of second stage L7 dispatchers.

13. The system of claim 10 wherein each server is connected to the plurality of second stage dispatchers.

14. The system of claim 7 wherein at least one of the second stage dispatchers is configured for sending packets of a first type to a first one of the servers for processing, and packets of a second type to a second one of the servers for processing.

15. The system of claim 7 wherein the first stage dispatcher and the second stage dispatchers are application-space dispatchers.

16. The system of claim 15 wherein the first stage dispatcher and the second stage dispatchers are application-space dispatchers running on COTS hardware.

17. The system of claim 16 wherein the first stage dispatcher and the second stage dispatchers are application-space dispatchers running on COTS hardware executing COTS OS software.

18. A computerized method for processing packets in a cluster-based server, the method comprising:
receiving a packet with a first stage dispatcher;
sending the received packet from the first stage dispatcher to one of a plurality of second stage dispatchers; and
forwarding the received packet from said one of the second stage dispatchers to one of a plurality of servers for processing.

19. The computerized method of claim 18 further comprising selecting said one of the second stage dispatchers for handling the received packet prior to sending the received packet from the first dispatcher to said one of the second stage dispatchers.

20. The computerized method of claim 18 further comprising selecting said one of the servers for processing the received packet prior to forwarding the received packet from said one of the second stage dispatchers to said one of the servers.

21. The computerized method of claim 20 wherein selecting includes selecting said one of the servers for processing packets of a first type, and selecting another server for processing packets of a second type.

22. The computerized method of claim 18 wherein forwarding includes forwarding the received packet from said one of the second stage dispatchers to said one of the servers via another one of the second stage dispatchers.

23. The computerized method of claim 18 further comprising bypassing the first stage dispatcher when sending a response from said one of the second stage dispatchers to an originator of the received packet.

24. The computerized method of claim 18 further comprising receiving, at one of the second stage dispatchers, a packet having a cookie created by one of the servers, and forwarding said packet having a cookie from said one of the second stage dispatchers to said server that created the cookie.

25. The computerized method of claim 24 wherein forwarding includes identifying a second stage dispatcher connected to said server that created the cookie, and forwarding the packet having a cookie to the identified second stage dispatcher.

26. The computerized method of claim 25 wherein identifying includes accessing a configuration file identifying connections between second stage dispatchers and servers.

27. The computerized method of claim 25 wherein identifying includes sending a message to second stage dispatchers and receiving a reply to said message from a second stage dispatcher connected to the server that created the cookie.

28. A computer-readable medium having computer-executable instructions for performing the computerized method of claim 18.
